(19) United States
(12) Patent Application Publication
(10) Pub. No.: US 2021/0062680 A1
(43) Pub. Date: Mar. 4, 2021

(54) GAS TURBINE ENGINE OF AN AIRCRAFT

(71) Applicant: Rolls-Royce Deutschland Ltd & Co KG, Blankenfelde-Mahlow (DE)

(72) Inventor: Stefan FECHNER, Berlin (DE)

(21) Appl. No.: 17/003,474

(22) Filed: Aug. 26, 2020

(30) Foreign Application Priority Data
Aug. 27, 2019 (DE) 10 2019 123 002.0

(51) Int. Cl. F01D 25/16; F02C 7/06; F02C 9/24

(52) U.S. Cl. CPC F01D 25/168; F02C 9/24; F02C 7/06

(57) ABSTRACT

A description is given of a gas turbine engine of an aircraft, having an engine core which comprises at least one compressor and at least one turbine, through which a core air flow is passed and which are rotatably mounted in the region of bearings. Part of the core air flow flows out of the engine core as a partial air flow into a region situated radially inside the engine core. A device which at least partially deflects the flow of the partial air flow in such a way that a static pressure in the region downstream of the device is lower than upstream of the device is provided in the flow path of the partial air flow, in the transitional region between the engine core and the radially inner region, and thus an axial bearing force starting from a surface on which the lower pressure acts is reduced.

This application claims priority to German Patent Application DE102019123002.0 filed Aug. 27, 2019, the entirety of which is incorporated by reference herein.

The present disclosure relates to a gas turbine engine of an aircraft, having an engine core which comprises at least one compressor and at least one turbine.

DE 10 2008 023 990 A1 discloses a two-shaft engine for an aero gas turbine having a central low-pressure shaft and a high-pressure shaft coaxially surrounding the latter. The low-pressure shaft and the high-pressure shaft are supported on the engine casing by means of bearing units. Bearing loads on the high-pressure shaft and the low-pressure shaft may be directed upstream or downstream with respect to the direction of a fan. To reduce the bearing load on what is referred to as the high-pressure bearing unit, the opposed bearing loads of the low-pressure shaft and high-pressure shaft are partially compensated in a structurally complex manner by supporting a front thrust bearing unit of the high-pressure shaft on the engine casing and a front thrust bearing unit of the low-pressure shaft on the high-pressure shaft.

Axial bearing loads in gas turbine engines are composed of various force components. Some of these loads result from pressures acting on rotating regions of compressors or turbines that are connected to a core shaft of a gas turbine engine. Here, the pressures each correspond to the pressures in an engine core if some of the air volume flow passed through the engine core flows away radially inward upstream or downstream of a compressor or turbine disk. This is the case to enable an aircraft or airplane embodied with a gas turbine engine of this kind to be supplied with “bleed air” and with thermal energy in order, for example, to cool regions of a gas turbine engine.

JPH0559901 A and JPH06264769 A each disclose an axial load adjustment mechanism which comprises a control valve, by means of which a pressure in the gas turbine engine can be adjusted. The control valves are each actuated in a pressure-dependent manner, but this is only possible by a correspondingly high complexity in terms of control and regulation, which is achievable only with difficulty for operation of a gas turbine engine of an aircraft, which must meet high safety standards.

The present disclosure is based on the object of making available a gas turbine engine of an aircraft, having an engine core, which is distinguished by low bearing loads, which can be operated with a low complexity in terms of control and regulation and which is distinguished by a simple construction in terms of design.

This object is achieved by a gas turbine engine having the features of Patent Claim 1.

According to a first aspect, a gas turbine engine of an aircraft having an engine core is provided. The engine core comprises at least one compressor and at least one turbine, through which a core air flow is passed and which are rotatably mounted in the region of bearings. Part of the core air flow flows out of the engine core as a partial air flow into a region situated radially inside the engine core. A device which at least partially deflects the flow of the partial air flow in such a way that a static pressure in the region downstream of the device is lower than upstream of the device is provided in the flow path of the partial air flow, in the transitional region between the engine core or core air flow and the radially inner region.

By means of the device, there is the possibility of reducing axial bearing forces in the region of the bearings in comparison with known engine solutions in a manner which is simple in terms of design and without additional complexity in terms of control and regulation. By virtue of the reduction in the axial bearing forces, the bearings of the gas turbine engine according to the present disclosure can be of smaller dimensions, and a life of the bearings can be improved with little outlay.

The arrangement of the device in the transitional region between the engine core or the core air flow and the radially inner region offers the possibility of relieving the loads on the bearings to a great extent since a relatively low pressure is then applied to regions of the gas turbine engine over a diameter region which is as large as possible, and this pressure is decisively responsible for the axial bearing loads in the region of the bearings.

In an advantageous development of the gas turbine engine according to the present disclosure, the device comprises at least one element which projects from a wall delimiting the flow path into the flow path of the partial air flow and in the region of which the flow of the partial air flow is influenced in such a way that, in particular, the static pressure downstream of the element is lower than upstream of the element, and an axial bearing force is thus reduced.

In an embodiment of simple design of the gas turbine engine according to the present disclosure, the element is of hook-type design and at least partially imposes upon the partial air flow downstream of the element a flow direction opposed to the flow direction from the engine core. The imposed backflow, in turn, brings about the desired pressure reduction downstream of the device and thus in the axial bearing loads in the region of the bearings without additional complexity in terms of control and regulation.

In another advantageous embodiment of the gas turbine engine according to the present disclosure, part of the partial air flow impinges upon a concave region of the hook-type element, whereby, in turn, the pressure downstream of the device is reduced in comparison with the pressure upstream of the device in a simple manner.

The device can have at least two elements, which project from walls delimiting the flow path into the flow path of the partial air flow and overlap one another in the region of their free ends and are spaced apart from one another in the flow direction of the partial air flow. This ensures in a simple manner that the partial air flow flows in the form of waves past the free ends of the elements in such a way that the total pressure and the static pressure downstream of the elements is lower than the total pressure and the static pressure upstream of the elements.

The device can also have a swirl generator, in the region of which the partial air flow is deflected in some region or regions in the circumferential direction of the engine core. By virtue of the deflection of the partial air flow in the circumferential direction of the engine core, the static pressure downstream of the device is, in turn, reduced to the desired extent, thereby reducing the axial bearing loads in the region of the bearings in comparison with known gas turbine engine solutions.

The swirl generator can comprise a plurality of elements which project into the flow path of the partial air flow and are preferably of propeller-blade-type design and which are spaced apart from one another in the circumferential direction of the engine core.

If the partial air flow downstream of an outlet of the compressor, which is preferably embodied as a high pressure compressor, flows radially inward out of the engine core, the reduction in the axial bearing loads by the device is particularly effective since the highest pressures in the region of a gas turbine engine are usually present in the region of the outlet of the high-pressure compressor.

It is self-evident to a person skilled in the art that a feature or parameter described in relation to one of the above aspects can be applied to any other aspect, unless these are mutually exclusive. Furthermore, any feature or any parameter described here may be applied to any aspect and/or combined with any other feature or parameter described here, unless these are mutually exclusive.

Embodiments will now be described, by way of example, with reference to the figures.

In the figures:

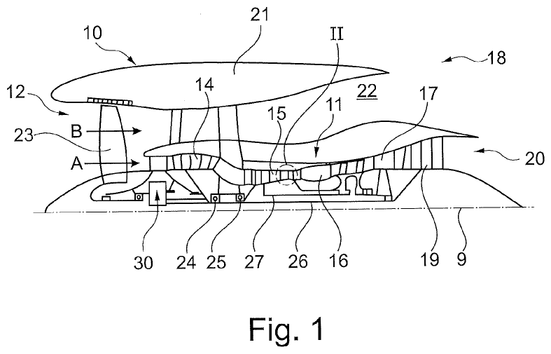

FIG. 1 shows a highly schematized longitudinal section through a gas turbine engine of an aircraft;

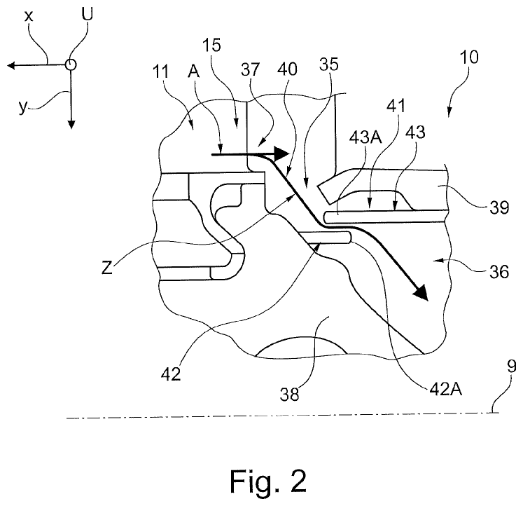

FIG. 2 shows an enlarged view of a region II, designated more specifically in FIG. 1, in which a first embodiment of a device by means of which a flow of a partial air flow flowing out of the engine core can be at least partially deflected is provided;

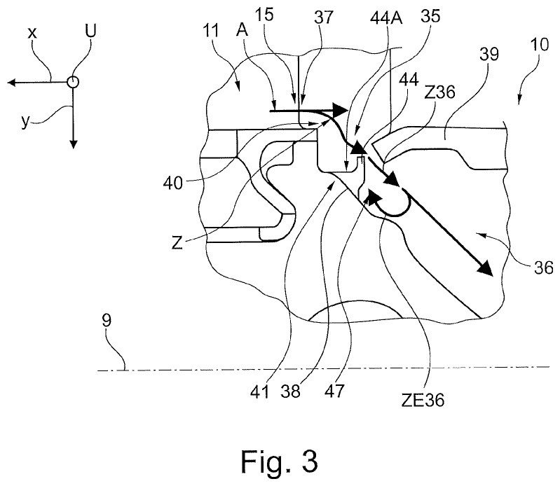

FIG. 3 shows an illustration corresponding to that of FIG. 2 of a further embodiment of the gas turbine engine according to FIG. 1;

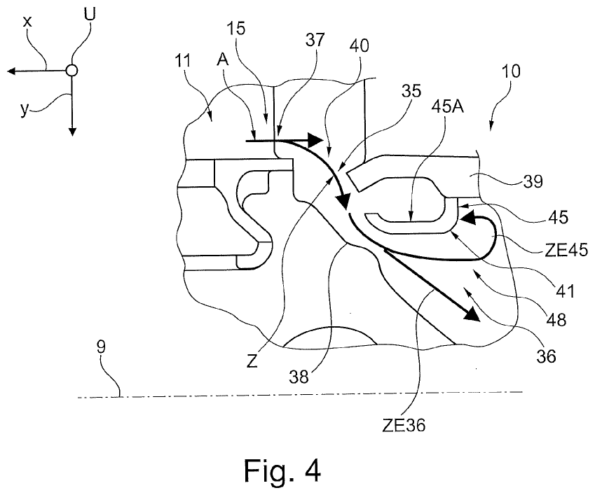

FIG. 4 shows an illustration corresponding to that of FIG. 2 of a further embodiment of the gas turbine engine according to FIG. 1; and

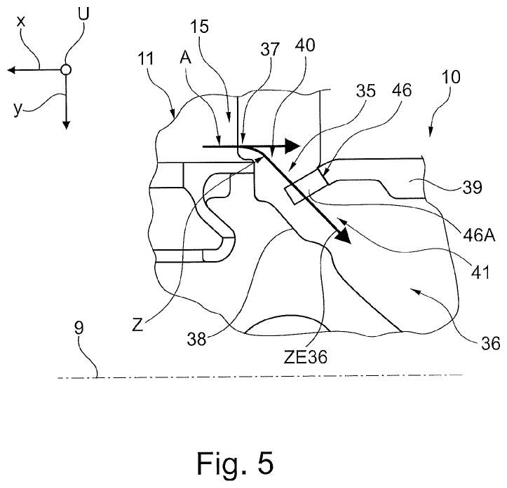

FIG. 5 shows an illustration corresponding to that of FIG. 2 of a further embodiment of the gas turbine engine according to FIG. 1.

FIG. 1 shows a gas turbine engine 10 with a main axis of rotation 9. The gas turbine engine 10 comprises an air inlet 12 and a fan 23 that generates two air flows: a core air flow A and a bypass air flow B. The gas turbine engine 10 furthermore comprises an engine core 11 that receives the core air flow A. In the axial flow direction, the engine core 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 by way of a shaft 26 and an epicyclic gear box 30. In the present case, the shaft 26 is mounted rotatably on the casing by means of bearings 24 and 25.

During operation of the gas turbine engine 10, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive said turbines, before they are expelled through the nozzle 20 to provide a certain thrust. The high-pressure turbine 17 drives the high-pressure compressor 15 by means of a suitable connecting shaft 27. The fan 23 generally provides the major part of the propulsive thrust. The epicyclic gear box 30 is a reduction gear box.

Attention is drawn to the fact that the expressions “low-pressure turbine” and “low-pressure compressor”, as used herein, can be taken to mean the lowest-pressure turbine stage and lowest-pressure compressor stage (i.e. not including the fan 23), respectively, and/or the turbine and compressor stages that are connected together by the connecting shaft with the lowest rotational speed in the gas turbine engine (i.e. not including the gear box output shaft that drives the fan 23). Alternatively, there is furthermore also the possibility that the low-pressure turbine and the low-pressure compressor to which reference is made here are the medium-pressure turbine and the medium-pressure compressor. Where such alternative nomenclature is used, the fan can be referred to as a first, or lowest-pressure, compression stage.

Other gas turbine engines in which the present disclosure can be used may have alternative configurations. For example, such engines may have an alternative number of compressors and/or turbines and/or an alternative number of connecting shafts. As a further example, the gas turbine engine shown in FIG. 1 has a split flow nozzle 20, 22. This means that the flow through the bypass duct 22 has a dedicated nozzle which is separate from the engine core nozzle 20 and radially on the outside thereof. However, this is not restrictive, and any aspect of the present disclosure can also apply to engines in which the flow through the bypass duct 22 and the flow through the core 11 are mixed or combined before (or upstream of) a single nozzle, which may be referred to as a mixed flow nozzle. One or both nozzles (whether mixed or split flow) can have a fixed or variable area. Although the example described relates to a turbofan engine, the disclosure can be applied, for example, to any type of gas turbine engine, such as, for example, an open rotor engine (in which the fan stage is not surrounded by an engine nacelle) or a turboprop engine. In some arrangements, the gas turbine engine 10 may not comprise a gear box 30.

The geometry of the gas turbine engine 10, and components thereof, is or are defined using a conventional axis system which comprises an axial direction x (which is aligned with the axis of rotation 9), a radial direction y (in the direction from bottom to top in FIG. 1), and a circumferential direction U (perpendicular to the view in FIG. 1). The axial direction x, the radial direction y and the circumferential direction U run perpendicular to one another.

FIG. 2 to FIG. 5 each show a region II, designated more specifically in FIG. 1, which in each case represents a transitional region 35 between the engine core 11 and a region 36 situated radially inside the engine core 11. In the present case, the transitional region 35 directly adjoins an outlet 37 of the high-pressure compressor 15, in the region of which the highest pressure is present in the gas turbine engine 10. In the present case, the radially inner region 36 is delimited by a rotating component 38 and a component 39 fixed with respect to the casing. In the transitional region 35 between the engine core 11 and the radially inner region 36, an annular gap 40 at the circumference is provided, through which part of the core air flow A passed through the engine core 11 or a partial air flow Z in the direction of the radially inner region 36 flows substantially radially inward.

A device 41 is provided in the flow path of the partial air flow Z downstream of the annular gap 40 at the circumference, in the transitional region 35 between the engine core 11 and the radially inner region 36. The device 41 partially deflects the flow of the partial air flow Z in such a way that a static pressure in the region downstream of the device 41 is lower than upstream of the device.

For this purpose, the device 41 in the exemplary embodiment, illustrated in FIG. 2, of the gas turbine engine has two elements 42, 43. The elements 42, 43 project in an axial direction x from walls delimiting the flow path or from the rotating component 38 and the component 39 fixed with respect to the casing into the flow path of the partial air flow Z. In the region of their free ends 42A, 43A, the elements 42 and 43 overlap one another in the axial direction x of the gas turbine engine. In addition, the elements 42 and 43 are spaced apart from one another in the flow direction of the partial air flow Z or radial direction y. The embodiment of the elements 42 and 43 and the arrangement of the elements 42 and 43 relative to one another have the effect that the partial air flow Z flows in the form of waves past the free ends 42A and 43A of the elements 42 and 43. This has the effect that the static pressure downstream of the elements 42 and 43 is lower than the static pressure upstream of the elements 42 and 43.

FIG. 3 shows an illustration, corresponding to FIG. 2, of another exemplary embodiment of the gas turbine engine 10, in which the device 41 is designed with an element 44 of substantially hook-type design. In the present case, the hook-shaped or hook-type element 44 is firmly connected to the rotating component 38 and projects in the axial direction x and in the radial direction y into the flow path of the partial air flow Z, starting from the rotating component 38 delimiting the flow path of the partial air flow Z. In this case, the hook-type element 44 is of concave design in a region 44A facing the partial air flow Z. As a result, a flow direction ZE36 opposed to the flow direction Z36 is partially imposed upon the partial air flow Z downstream of the hook-type element 44, with the result that the partial air flow Z downstream of the element 44 has a recirculation zone 47. This has the effect that the pressure downstream of the hook-shaped element 44 is lower than upstream of the hook-shaped element 44.

FIG. 4 likewise shows a device 41 which is embodied with a hook-type or hook-shaped element 45. In the exemplary embodiment shown in FIG. 4, the hook-shaped element 45 is firmly connected to the component 39 fixed with respect to the casing and projects into the flow path of the partial air flow Z substantially in the axial direction x, starting from the component 39 fixed with respect to the casing. The hook-shaped element 45 is likewise formed with a region that faces the partial air flow Z upstream of the device 41 and has a concave region 45A. A backflow ZE45 is thereby partially imposed on the partial air flow Z downstream of the hook-shaped element 45, said backflow resulting in a recirculation zone 48 downstream of the element 45 that deviates from the flow direction Z36 in the radially inner region and has the effect that the pressure in the radially inner region 36 downstream of the hook-shaped element 45 is lower than upstream of the hook-shaped element 45.

The further exemplary embodiment, illustrated in FIG. 5, of the gas turbine engine 10 is embodied in the transitional region 35 with a device 41 that comprises a swirl generator 46. The swirl generator 46, in turn, comprises elements 46A spaced apart from one another in the circumferential direction of the engine core 11. In the exemplary embodiment according to FIG. 5, the elements 46A each project at least approximately obliquely inward in the axial direction x and in the radial direction y into the flow path Z36 of the partial air flow Z, starting from the component 39 fixed with respect to the casing. In the present case, the elements 46A are of at least approximately propeller-blade-type design and deflect part of the partial air flow Z in the circumferential direction U. This, in turn, has the effect that, in particular, the static pressure downstream of the device 41 in the radially inner region 36 is lower than the static pressure upstream of the device 41.

In all the exemplary embodiments described above, the pressure downstream of the device 41 is reduced in the region of the device 41 relative to the pressure upstream of the device 41, without additional control and regulation. Since the pressure downstream of the device 41 acts on the surface of the rotating component 38 which delimits the radially inner region 36, axial bearing forces of the bearings 24, 25 are thereby reduced in comparison with gas turbine engines known from the prior art that are embodied without a corresponding device.

### LIST OF REFERENCE SIGNS

9 Main axis of rotation
10 Gas turbine engine
11 Engine core
12 Air inlet
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass duct
23 Fan
24, 25 Bearing
26 Shaft
27 Shaft
30 Epicyclic gear box
35 Transitional region
36 Radially inner region
37 Outlet of the high-pressure compressor
38 Rotating component
39 Component fixed with respect to the casing
40 Annular gap at the circumference
41 Device
42 Element
42A Free end of element 42
32 Element
42A Free end of element 43
44 Hook-type element
44A Concave region of the hook-type element 44
45 Hook-shaped element
45A Concave region of the hook-shaped element 45
46 Swirl generator
46A Element
47 Recirculation zone
48 Recirculation zone
A Core air flow
B Bypass air flow
U Circumferential direction
Z Partial air flow
Z36, ZE36, ZE45 Flow direction of the partial air flow
x Axial direction
y Radial direction

1. A gas turbine engine of an aircraft, having an engine core which comprises at least one compressor and at least one turbine, through which a core air flow is passed and which are rotatably mounted in the region of bearings, wherein part of the core air flow flows out of the engine core as a partial air flow into a region situated radially inside the engine core, and wherein a device which at least partially deflects the flow of the partial air flow in such a way that a static pressure in the region downstream of the device is lower than upstream of the device is provided in the flow path of the partial air flow, in the transitional region between the engine core and the radially inner region.

2. The gas turbine engine according to claim 1, wherein the device comprises at least one element which projects from a wall delimiting the flow path into the flow path of the partial air flow and in the region of which the flow of the partial air flow is influenced in such a way that the static pressure downstream of the element is lower than upstream of the element, and an axial bearing force is thus reduced.

3. The gas turbine engine according to claim 2, wherein the element is of hook-type design and at least partially imposes upon the partial air flow downstream of the element a flow direction opposed to the flow direction from the engine core.

4. The gas turbine engine according to claim 3, wherein part of the partial air flow impinges upon a concave region of the hook-type element.

5. The gas turbine engine according to claim 2, wherein the device has at least two elements, which project from walls delimiting the flow path into the flow path of the partial air flow and overlap one another in the region of their free ends and are spaced apart from one another in the flow direction of the partial air flow, with the result that the partial air flow flows in the form of waves past the free ends of the elements in such a way that the static pressure downstream of the elements is lower than the static pressure upstream of the elements.

6. The gas turbine engine according to claim 1, wherein the device has at least one swirl generator, in the region of which the partial air flow is deflected in some region or regions in the circumferential direction of the engine core.

7. The gas turbine engine according to claim 6, wherein the swirl generator comprises a plurality of elements which project into the flow path of the partial air flow and are preferably of propeller-blade-type design and which are spaced apart from one another in the circumferential direction of the engine core.

8. The gas turbine engine according to claim 1, wherein the partial air flow downstream of an outlet of the compressor flows radially inward out of the engine core.
